(19) United States
(12) Patent Application Publication
(10) Pub. No.: US 2007/0254987 A1
(43) Pub. Date: Nov. 1, 2007

(54) SIDING PANEL FORMED OF POLYMER AND WOOD FLOUR

(75) Inventors: Daniel E. Festa, Strongsville, OH (US); Walter M. Krause, Ashland, OH (US)

Correspondence Address: BANNER & WITCOFF, LTD., 28 STATE STREET, 28th FLOOR, BOSTON, MA, 02109-9601, US

(73) Assignee: Associated Materials, Inc., Cuyahoga Falls, OH (US)

(21) Appl. No.: 11/380,243

(22) Filed: Apr. 26, 2006

(51) Int. Cl. B29C 47/00

(52) U.S. Cl. 524/13; 524/425

(57) ABSTRACT

A composite siding panel includes PVC resin, wood flour in an amount of about 88.33 to about 132.5 parts per hundred parts of PVC resin, a stabilizer in an amount of about 1.2 parts per hundred parts of PVC resin, wax in an amount of about 0.25 to about 0.35 parts per hundred parts of PVC resin, and a wood stabilizer in an amount of about 0.5 to about 3 parts per hundred parts of PVC resin.

### FIELD OF THE INVENTION

This invention relates generally to a composite siding panel and, in particular, to a composite siding panel formed of a polymer and wood flour.

### BACKGROUND OF THE INVENTION

Siding products for building structures can be formed of many materials, including wood, polymer or vinyl materials such as polyvinyl chloride (PVC), and fiber cement. It is desirable to produce a siding product that provides weatherability, durability, low maintenance, and adaptability to various architectures. Vinyl siding is very flexible, which means that it will follow a wall very closely. Wood and fiber cement products, on the other hand, are more rigid, allowing the siding to help true a wall that is uneven.

It is an object of the present invention to provide a siding panel that reduces or overcomes some or all of the difficulties inherent in prior known devices. Particular objects and advantages will be apparent to those skilled in the art, that is, those who are knowledgeable or experienced in this field of technology, in view of the following disclosure of the invention and detailed description of certain embodiments.

### SUMMARY

The principles of the invention may be used to advantage to provide a composite panel formed of a polymer and wood flour. In accordance with a first aspect, a composite siding panel includes PVC resin, wood flour in an amount of about 88.33 to about 132.5 parts per hundred parts of PVC resin, a stabilizer in an amount of about 1.2 parts per hundred parts of PVC resin, wax in an amount of about 0.25 to about 0.35 parts per hundred parts of PVC resin, and a wood stabilizer in an amount of about 0.5 to about 3 parts per hundred parts of PVC resin

In accordance with another aspect, a composite siding panel includes PVC resin, wood flour in an amount of about 88.33 to about 132.5 parts per hundred parts of PVC resin, a stabilizer in an amount of about 1.2 parts per hundred parts of PVC resin, wax in an amount of about 0.25 to about 0.35 parts per hundred parts of PVC resin, a wood stabilizer in an amount of about 0.5 to about 3 parts per hundred parts of PVC resin, a process aid in an amount of about 10 to about 14 parts per hundred parts of PVC resin, an impact modifier in an amount of about 2 parts per hundred parts of PVC resin, a lubricating process aid in an amount of about 1 to about 3 parts per hundred parts of PVC resin, and calcium carbonate in an amount of about 5 to about 25 parts per hundred parts of PVC resin.

In accordance with a further aspect, a composite siding panel including PVC resin, wood flour in an amount of about 97.93 parts per hundred parts of PVC resin, a stabilizer in an amount of about 1.2 parts per hundred parts of PVC resin, wax in an amount of about 0.3 parts per hundred parts of PVC resin, a wood stabilizer in an amount of about 1 part per hundred parts of PVC resin, a process aid in an amount of about 12 parts per hundred parts of PVC resin, an impact modifier in an amount of about 2 parts per hundred parts of PVC resin, a lubricating process aid in an amount of about 2 parts per hundred parts of PVC resin, calcium carbonate in an amount of about 5 to about 25 parts per hundred parts of PVC resin, and a lubricant in an amount of about 4 parts per hundred parts of PVC resin.

Substantial advantage is achieved by providing a composite panel formed of a polymer and wood flour. In particular, certain embodiments of a polymer and wood flour composite siding panel exhibit the best attributes of existing exterior cladding materials, e.g., appearance, durability, maintenance and cost. Such composite panels have low maintenance, excellent weatherability and durability, and can easily be adapted to various architectures. Such composite panels also are somewhat flexible, resulting in less breakage at job sites, while at the same time being rigid enough to help true an uneven wall.

These and additional features and advantages disclosed here will be further understood from the following detailed disclosure of certain embodiments.

### BRIEF DESCRIPTION OF THE DRAWINGS

FIG. 1 is a perspective view of a composite siding panel.

The figure referred to above is not drawn necessarily to scale and should be understood to provide a representation of the invention, illustrative of the principles involved. Some features of the composite panel of a polymer and wood flour depicted in the drawing have been enlarged or distorted relative to others to facilitate explanation and understanding. Composite panels of a polymer and wood flour as disclosed herein would have configurations and components determined, in part, by the intended application and environment in which they are used.

### DETAILED DESCRIPTION OF CERTAIN PREFERRED EMBODIMENTS

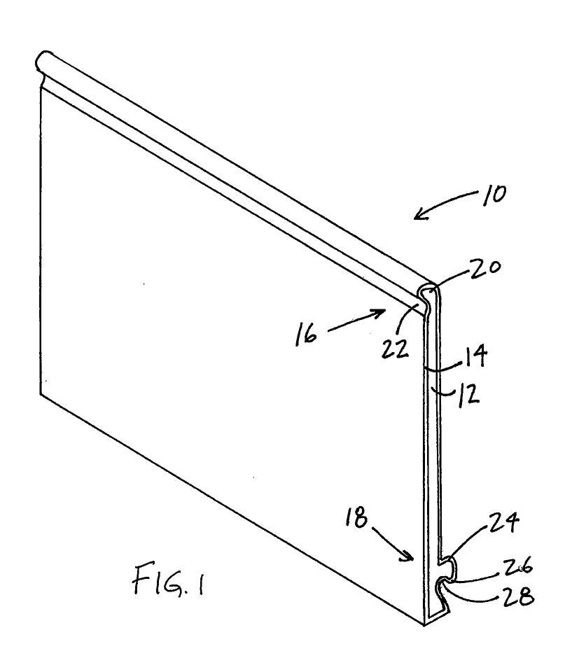

The present invention may be embodied in various forms. A preferred embodiment of a composite panel 10 is shown in FIG. 1. Composite panel 10 may be used, for example, as a siding material for a building. In the illustrated embodiment panel 10 has a core 12 encased within a cap 14. In certain embodiments, panel 10 may not include cap 14. Panel 10 includes a top lock 16 proximate a top edge of panel 10, and a bottom lock 18 proximate a bottom edge of the panel. Top and bottom locks 16, 18 can have a wide range of shapes, and are configured to have complimentary shapes so that vertically adjacent siding panels can be interlocked together.

In certain embodiments, top lock 16 includes a reduced thickness portion 20 that is angled slightly outwardly and defines a groove 22 along a front surface of panel 10. Bottom lock 18 includes a flange 24 extending rearwardly from panel 10 proximate its bottom edge, and terminates in a lip 26 extending downwardly from a rear edge of flange 24. A recess 28 is formed in a rear surface panel 10 beneath flange 24. In a preferred embodiment, recess 28 curves inwardly and upwardly and is configured to mate with and receive the angled reduced thickness portion 20 of a vertically adjacent panel 10. Panel 10 is secured to a horizontally adjacent panel via a splicer. The splicer and installation of panel 10 on a building structure are described in greater detail in U.S. application Ser. No. 10/911,932, the entire disclosure of which is incorporated herein by reference for all purposes.

Core 12 of panel 10 is formed of a composite of a thermoplastic polymer, wood flour and additional materials. In certain embodiments, panel 10 is formed primarily of polyvinyl chloride (PVC) resin and wood flour. The PVC resin serves as the body or primary structure of panel 10, and, in certain embodiments, comprises about 43.4% total weight of panel 10. Wood flour, which is formed of small wood particles, acts as a cellulose filler and, therefore, significantly reduces the cost of a polymer siding panel. In certain embodiments, 40 mesh wood flour is used, with the particles having a maximum dimension of approximately 425 microns, or 0.425 mm.

The wood flour helps produce a stiffer, more stable product. Further, the wood flour serves to reduce the thermal expansion of the siding panel, resulting in a significant reduction in movement of the siding panel along the wall or other structure upon which it is installed. By reducing the movement of the panels, butt seams rather than overlapping seams can be used, improving the appearance of the siding.

In certain embodiments between about 88.33 parts per hundred resin (pphr) and about 132.5 pphr of wood flour is combined with the polymer, or between about 40% and about 50% total weight. In certain embodiments about 97.93 pphr of wood flour is used, or about 42.5% total weight of the composite panel.

A stabilizer is used to stabilize the PVC resin, helping reduce the chances of burning or degrading of the PVC resin during processing. In certain embodiments, about 1.2 pphr, or about 0.52% total weight of stabilizer is used. Suitable stabilizers include methyl tin stabilizers, e.g., liquid tin mercaptide materials, such as ADVASTAB® TM-181, supplied by Rohm and Haas.

Wax is added to the composite panel mixture, and serves to act as an external lubricant or mold release, thereby improving the manufacturability of the composite panel. In certain embodiments, between about 0.25 pphr and about 0.35 pphr wax is used, or between about 0.11% and about 0.15% total weight. In certain embodiments, about 0.3 pphr, or, about 0.13% total weight wax is used. Suitable waxes include oxided polyethylene homopolymers such as AC316A supplied by Honeywell.

A wood stabilizer is also added, which helps to stabilize the wood flour and reduce the chances of burning and degrading of the wood flour during processing. In certain embodiments between about 0.5 pphr and about 3 pphr wood stabilizer is used, or between about 0.2% and about 1.3% total weight. In other embodiments, about 1 pphr, or about 0.43% total weight wood stabilizer is used.

In certain embodiments, process aids are added to the mixture. The process aids help promote fusion of the PVC resin during extrusion processing and to help develop a uniform cell structure. They also help to develop substantial melt strength in a smooth-surfaced, foamed PVC extrudate at relatively low densities. In certain embodiments, between about 10 pphr and about 14 pphr, or between about 4.4% and about 6% total weight process aids are used. In certain embodiments, about 12 pphr, or about 5.2% total weight of process aids are added to the composite mixture. Suitable process aids include all-acrylic polymers such as Paraloid K-400, provided by Rohm and Haas.

An impact modifier may also be added to the composite mixture in order to improve resistance of the composite panel to impacts. In certain embodiments, about 2 pphr, or about 0.87% total weight process aids are added to the composite mixture. An exemplary impact modifier is methacrylate butadiene styrene, such as BTA-753 supplied by Rohm and Haas.

A lubricating process aid may also be used to promote fusion and melt homogeneity in the early stages of the extrusion process. Additionally, the lubricating process aid acts as an external lubricant to provide metal release, thereby helping prevent the PVC from adhering to the heated surfaces of the extrusion equipment. In certain embodiments, between about 1 pphr and about 3 pphr, or between about 0.4% and about 1.3% total weight process aids are used. In certain embodiments, about 2 pphr, or about 0.87% total weight of process aids are added to the composite mixture. Suitable lubricating process aids include acrylic polymers, such as K175 supplied by Rohm and Haas.

Calcium carbonate may also be added to the composite panel mixture, acting as a mineral filler with the product matrix. In certain embodiments, between about 5 pphr and about 25 pphr, or between about 2.2% and about 10.2% total weight calcium carbonate is used. In certain embodiments, about 10 pphr, or about 4.34% total weight calcium carbonate is added to the composite mixture.

A lubricant may also be used during formation of the composite panel. In certain embodiments, lubricant in an amount between about 3 pphr and about 5 pphr, or between about 1.3% and about 2.2% total weight is added. In certain embodiments, about 4 pphr, or about 1.74% total weight lubricant is added to the composite mixture. The lubricant serves to help process the wood and resin composite. Exemplary lubricants include blends of waxes, oleo chemicals and aliphatic resins, such as SA0413 supplied by Struktol Company of America.

One example of an embodiment of composite panel 10 is illustrated in the following table:

TABLE 1

| | Parts Per Hundred | |
|---|---|---|
| Element | Resin (pphr) | Percentage (%) |
| PVC Resin | 100 | 43.4 |
| Wood Flour | 97.93 | 42.5 |
| Stabilizer | 1.2 | 0.52 |
| Wax | 0.3 | 0.13 |
| Process Aid | 12 | 5.2 |
| Impact Modifier | 2 | 0.87 |
| Wood Stabilizer | 1 | 0.43 |
| Lubricating Process Aid | 2 | 0.87 |
| Lubricant | 4 | 1.74 |
| Calcium Carbonate | 10 | 4.34 |
| TOTAL | 230.43 | 100 |

Cap 14 may be formed of PVC, for example. Cap 14 provides a protective cover for panel 10, enhancing the weatherability of composite panel 10, and eliminating the need to paint the panel.

To form panel 10, the PVC resin, stabilizer, wax, process aid, impact modifier, wood stabilizer, lubricant, lubricating process aid, and calcium carbonate are mixed in a high intensity blender. They are then heated to a temperature greater than about 248° F., and then cooled in a cool mixer to about 120° F. The resulting powdered mixture is then bagged and taken to an extruder.

At the extruder, the powdered material and wood flour are augured into two separate gravimetric feeders that drop material into a main hopper. The materials then travel through a two-stage tumbler and a material pre-conditioner, and are then fed into a twin screw parallel extruder. The material is then extruded through a high pressure die. The extruded material is then further processed with either calibration or a belt. With calibration, a calibrator is positioned close to, but not touching, the die. The calibrator cools and maintains the profile of the panel as it exits the die. With the belt, the material exits the die and is fed into a twin belt system. The extrudate fills the cavity between the belts, and the material is embossed and shaped into a substantially flat panel, including any desired lips or other features. The belt cools the panel to some extent, and a water-cooled tank is used to finish the cooling process.

The resultant panel 10 provides a siding material with excellent appearance and durability, and low maintenance and cost. The PVC component provides panel 10 with flexibility, while the added flour gives it enough rigidity to allow the panel to help true a wall that is uneven.

In light of the foregoing disclosure of the invention and description of various embodiments, those skilled in this area of technology will readily understand that various modifications and adaptations can be made without departing from the scope and spirit of the invention. All such modifications and adaptations are intended to be covered by the following claims.

What is claimed is:

1. A composite siding panel comprising, in combination:
PVC resin;
wood flour in an amount of about 88.33 to about 132.5 parts per hundred parts of PVC resin;
a stabilizer in an amount of about 1.2 parts per hundred parts of PVC resin;
wax in an amount of about 0.25 to about 0.35 parts per hundred parts of PVC resin; and
a wood stabilizer in an amount of about 0.5 to about 3 parts per hundred parts of PVC resin.

2. The composite siding panel of claim 1, further comprising a process aid in an amount of about 10 to about 14 parts per hundred parts of PVC resin.

3. The composite siding panel of claim 1, further comprising an impact modifier in an amount of about 2 parts per hundred parts of PVC resin.

4. The composite siding panel of claim 1, further comprising a lubricating process aid in an amount of about 1 to about 3 parts per hundred parts of PVC resin.

5. The composite siding panel of claim 1, further comprising calcium carbonate in an amount of about 5 to about 25 parts per hundred parts of PVC resin.

6. The composite siding panel of claim 1, further comprising a lubricant in an amount of about 3 to about 5 parts per hundred parts of PVC resin.

7. The composite siding panel of claim 1, wherein the wood flour is present in an amount of about 97.93 parts per hundred parts of PVC resin.

8. The composite siding panel of claim 1, wherein the wax is present in an amount of about 0.3 parts per hundred parts of PVC resin.

9. The composite siding panel of claim 1, wherein the wood stabilizer is present in amount of about 1 part per hundred parts of PVC resin.

10. The composite siding panel of claim 1, wherein the process aid is present in an amount of about 12 parts per hundred parts of PVC resin.

11. The composite siding panel of claim 1, wherein the lubricating process aid is present in an amount of about 2 parts per hundred parts of PVC resin.

12. The composite siding panel of claim 1, wherein the calcium carbonate is present in an amount of about 10 parts per hundred parts of PVC resin.

13. The composite siding panel of claim 1, wherein the lubricant is present in an amount of about 4 parts per hundred parts of PVC resin.

14. A composite siding panel comprising, in combination:
PVC resin;
wood flour in an amount of about 88.33 to about 132.5 parts per hundred parts of PVC resin;
a stabilizer in an amount of about 1.2 parts per hundred parts of PVC resin;
wax in an amount of about 0.25 to about 0.35 parts per hundred parts of PVC resin;
a wood stabilizer in an amount of about 0.5 to about 3 parts per hundred parts of PVC resin;
a process aid in an amount of about 10 to about 14 parts per hundred parts of PVC resin;
an impact modifier in an amount of about 2 parts per hundred parts of PVC resin;
a lubricating process aid in an amount of about 1 to about 3 parts per hundred parts of PVC resin;
calcium carbonate in an amount of about 5 to about 25 parts per hundred parts of PVC resin; and
a lubricant in an amount of about 3 to about 5 parts per hundred parts of PVC resin.

15. A composite siding panel comprising, in combination:
PVC resin;
wood flour in an amount of about 97.93 parts per hundred parts of PVC resin;
a stabilizer in an amount of about 1.2 parts per hundred parts of PVC resin;
wax in an amount of about 0.3 parts per hundred parts of PVC resin;
a wood stabilizer in an amount of about 1 part per hundred parts of PVC resin;
a process aid in an amount of about 12 parts per hundred parts of PVC resin;
an impact modifier in an amount of about 2 parts per hundred parts of PVC resin;
a lubricating process aid in an amount of about 2 parts per hundred parts of PVC resin;
calcium carbonate in an amount of about 5 to about 25 parts per hundred parts of PVC resin; and
a lubricant in an amount of about 4 parts per hundred parts of PVC resin.
